(19) United States
(12) Patent Application Publication
(10) Pub. No.: US 2008/0017676 A1
(43) Pub. Date: Jan. 24, 2008

(54) Fluid switch with seal

(76) Inventors: Michael Ross Kessell, Auckland (NZ); Paul Neville Adams, Auckland (NZ); Edward Sean Scott, Auckland (NZ); Antonius Petrus Henricus Blijlevens, Auckland (NZ)

Correspondence Address: EDWARDS ANGELL PALMER & DODGE LLP, P.O. BOX 55874, BOSTON, MA, 02205, US

(21) Appl. No.: 11/716,841

(22) Filed: Mar. 12, 2007

Related U.S. Application Data
(60) Provisional application No. 60/781,447, filed on Mar. 10, 2006.
(60) Provisional application No. 60/818,826, filed on Jul. 6, 2006.

(51) Int. Cl. B67D 3/00

(52) U.S. Cl. 222/507

(57) ABSTRACT

A flow switch assembly comprising a valve housing which includes an upper body portion and a lower body portion. The upper and lower body portions define a chamber to capture a valve member. The housing includes an inlet and outlet to the chamber. A valve member is seated by the chamber of the valve housing. The valve member is mounted for movement between an open and closed position. A moving mechanism is operatively associated with the valve housing and the valve member for moving the valve member between the open position and the closed position when the upper body portion of the housing is rotated relative to the lower body portion. There is provision for sealing between the upper and lower housing and for sealing the outlet.

### CROSS REFERENCE TO RELATED APPLICATIONS

This application claims priority to U.S. Provisional Patent Application Ser. No. 60/781,447 filed Mar. 10, 2006 and U.S. Provisional Patent Application Ser. No. 60/818,826 filed Jul. 6, 2006, the disclosures of each are herein incorporated by reference in their entireties.

### FIELD OF THE INVENTION

The present invention relates to a fluid switch. Specifically although not solely the present invention relates to a fluid switch for or of a consumer beverage container such as a beverage or water bottle, preferably of a disposable kind, which incorporates a fluid switch at the spout end of the container to control the dispensing of liquid from the container.

Specifically although not solely the present invention may also relate to a fluid switch which may have application other than for beverage container applications.

### BACKGROUND

Drink containers which are currently in common use for the purposes of containing liquid such as water or energy type drinks, are very common. They normally incorporate a spout end which is engaged with a valve unit to control the dispensing of the liquid from the reservoir of the container. A valve used for such applications is for example described in U.S. Pat. No. 6,758,359. It consists of a valve housing and a movable valve element which moves in an axial direction to open and close an outlet opening of the unit.

Our now published PCT application WO2004/106782 references a basic version of a fluid switch (therein referred to as a valve) for use with a beverage container.

For valves of the kind as shown in U.S. Pat. No. 6,758,359, valve hygiene is an important factor. Overcaps may be provided to protect the valve from contamination. Such overcaps are normally made of a plastics material and can be relatively expensive to provide. Shrink wrap overcaps that can be pealed away and disposed of are also a form of protection against contamination that such valves may be provided with.

However none of these hygiene providing overcaps offer an additional seal to the valve. Certain drinks such as carbonated drinks can often not be closed by a valve closure of the kind as described in U.S. Pat. No. 6,758,359 because of leakage problems with the valve. Any build up in pressure inside the bottle can result in undesired leakage of liquid through the valve.

Drink containers such as those described in U.S. Pat. No. 6,758,359 normally incorporate a spout end which is engaged with a valve unit to control the dispensing of the liquid from the reservoir of the container. It consists of a valve housing and a movable valve element which moves in an axial direction to open and close an outlet opening of the unit.

For valves of the kind as shown in U.S. Pat. No. 6,758,359, sealing is an important factor. Overcaps may be provided to protect the valve from leaking. Such overcaps are normally made of a plastics material and are another expense.

It would be an advantage if an additional closure can be provided to a valve as for example described in WO2004/106782 which is sealed by a seal or similar closure which can also offer resistance against undesired leakage of liquid from the reservoir bottle or container to which the valve is engaged.

In this specification where reference has been made to patent specifications and other external documents, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

For the purposes of this specification, the term “labyrinth seal” is defined to mean a tortuous passage created at an interface between two complementary surfaces so as to utilise hydrodynamic, hydrostatic and/or or viscous forces to restrict the flow of a fluid between the surfaces, whether the surfaces are in motion relative to each other or not, and whether the surfaces make physical contact with each other or not.

Accordingly it is an object of the present invention to provide a fluid switch and/or container or dispenser with or a related fluid switch which addresses the abovementioned disadvantages or addresses the abovementioned desiderata or which will at least provide the public with a useful choice.

It is a further object of the present invention to provide a fluid switch which provides improvements over that disclosed in WO2004/106782 or which will at least provide the public with a useful choice.

### BRIEF DESCRIPTION OF THE INVENTION

Accordingly in a first aspect the present invention consists in a flow switch assembly comprising;
(i) a valve housing which includes an upper body portion and a lower body portion, the upper and lower body portions defining a chamber to capture a valve member, the housing including an inlet and outlet to said chamber;
(ii) a valve member seated by the chamber of the valve housing, said valve member mounted for movement between a position (herein after “open position”) allowing fluid passage between and/or via said inlet and said outlet and a position (herein after “closed position”) wherein said valve member seals at least one of said inlet and outlet; and
(iii) moving mechanism operatively associated with said valve housing and the valve member for moving the valve member between the open position and the closed position when the upper body portion of the housing is rotated relative to said lower body portion.

Preferably a seal (such as a seal (such as an induction seal)) is provided to the valve housing to seal the outlet.

Preferably when said valve member is in said open position, said valve member establishes at least one passage to allow fluid communication between said inlet and outlet.

Preferably said valve member is mounted by said chamber for rotation relative to said valve housing, about a first axis.

Preferably the moving of said valve member between the open position and the closed position by said moving mechanism operatively associated is actuated when the upper body portion of the housing is rotated relative to said lower body portion about an axis which is perpendicular to said first axis.

Preferably wherein said inlet is provided by said lower body portion and said outlet is provided by said upper body.

Preferably said seal (such as an induction seal) is engaged to said upper body and is located to close said opening of said upper body.

Preferably said inlet and said outlet are disposed opposite each other on the valve member.

Preferably said moving mechanism operatively associated with said valve housing and the valve member for moving the valve member between the open position and the closed position includes a camming mechanism.

Preferably the camming mechanism includes a cam surface formed on the exterior surface of the valve member and a cam pin formed on the interior surface of the upper body portion of the housing.

Preferably the cam surface is a slot into which the cam pin is located.

Preferably said lower body portion provides said inlet to said chamber, and wherein said lower body portion is integrally formed with a container said container including an opening contiguous said inlet to said chamber.

Preferably said container is a consumer beverage container.

Preferably said seal (such as an induction seal) is a plastic film (one or multiple).

Preferably said seal is a plastic cap that includes an annular lip that engages said upper body portion to seal said outlet.

Preferably said seal threadingly engages with a thread of the upper body portion.

Preferably said seal threadingly engages with a thread of the lower body portion.

Preferably said seal includes a wad seal to assist in sealing the outlet.

Preferably the upper body portion and the lower body portion engage with each other at an interface between an upper body engaging surface and a lower body engaging surface respectively.

Preferably the interface between the upper body engaging surface and the lower body engaging surface defines an interface passage.

Preferably the interface passage has an interface passage inlet at the chamber.

Preferably the interface passage has an interface passage outlet at the periphery of the valve housing.

Preferably the interface passage outlet is proximate the outlet and preferably about the outlet.

Preferably the interface passage outlet is proximate the inlet and preferably about the inlet.

Preferably the upper body portion is received into a recess in the lower body portion.

Preferably the lower body portion is received into a recess in the upper body portion.

Preferably the valve housing has a proximal end and a distal end.

Preferably the valve housing is cylindrical, having a proximal end and a distal end

Preferably the valve housing has a proximal end and a distal end and wherein the interface passage outlet is proximate the outlet on a distal end of the cylindrical housing.

Preferably the valve housing has a proximal end and a distal end and wherein the interface passage outlet is proximate the inlet on a distal end of the cylindrical housing.

Preferably said seal engages with the valve housing to restrict the flow of fluid from operationally flowing from the interface passage outlet.

Preferably the interface between the upper body portion and the lower body portion includes a labyrinth seal.

Preferably said flow switch includes a frangible tamper strip obstructing relative movement between the upper body portion and the lower body portion.

Preferably said tamper strip restricts the flow of fluid from operationally flowing from the interface outlet.

Preferably one of the upper body portion and the lower body portion is composed of a plurality of pieces in locking engagement.

In a second aspect the present invention consists in a consumer beverage container comprising;
(i) a container portion,
(ii) a lower valve body portion integrally formed with said container portion,
(iii) an upper valve body portion rotatably engaged with said lower valve body portion and defining with said lower valve body portion a chamber to capture a valve member, said lower valve body portion including a passage creating an inlet to said chamber to allow fluid passage between said container portion and said chamber, the upper valve body portion including an outlet to said chamber,
(iv) a valve member disposed within the chamber, said valve member mounted for movement between a position (hereinafter “open position”) allowing fluid passage between and/or via said inlet and said outlet and a position (hereinafter “closed position”) wherein said valve member seals at least one of said inlet and outlet,
(v) moving mechanism operatively associated with (i) at least one of (a) said upper and (b) lower valve body portions, and (ii) the valve member, for moving the valve member between the open position and the closed position when the upper valve body portion of the housing is rotated relative to said lower valve body portion;

Preferably a seal (such as an induction seal) is provided to seal the outlet Preferably the valve member is mounted for pivoting movement between the open position and closed position.

Preferably the valve member is at least partially spherical, and includes a passage through it.

Preferably the upper body portion and the lower body portion engage with each other at an interface between an upper body engaging surface and a lower body engaging surface respectively.

Preferably the interface between the upper body engaging surface and the lower body engaging surface defines an interface passage.

Preferably the interface passage has an interface outlet at or in fluid connection with the periphery of the valve housing.

Preferably the interface passage has an interface passage inlet at or in fluid connection with the chamber.

Preferably the interface passage outlet is proximate the outlet and preferably about the outlet.

Preferably the interface outlet is proximate the inlet and preferably about the inlet

Preferably the upper body portion is received into a recess in the lower body portion.

Preferably the lower body portion is received into a recess in the upper body portion.

Preferably said seal engages with the valve housing to restrict the flow of fluid from operationally flowing from the outlet and the interface outlet.

Preferably the upper body portion and the lower body portion engage with each other at an interface between an upper body engaging surface and a lower body engaging surface respectively and the interface between the upper body portion and the lower body portion includes a labyrinth seal.

Preferably said flow switch includes a frangible tamper strip obstructing relative movement between the upper body portion and the lower body portion.

Preferably said flow switch includes a frangible tamper strip obstructing relative movement between the upper body portion and the lower body portion.

Preferably the upper body portion and the lower body portion engage with each other at an interface between an upper body engaging surface and a lower body engaging surface respectively and wherein said tamper strip restricts the flow of fluid from operationally flowing from the interface outlet.

Preferably the upper body portion is composed of a plurality of pieces in locking engagement with each other.

Preferably the lower body portion is composed of a plurality of pieces in locking engagement with each other.

Preferably a plastic cap is provided that includes an annular lip that engages said upper body portion to seal said outlet.

Preferably said plastic cap threadingly engages with a thread of the upper body portion.

Preferably said plastic cap threadingly engages with a thread of the lower body portion.

In a further aspect the present invention consists in a fluid container comprising;
(i) a housing which includes an upper body portion and a lower body portion, the upper and lower body portions defining a chamber capturing a container member, the housing including an outlet to said chamber;
(ii) a container member disposed within the chamber of the housing, said container member including a reservoir to contain fluid and including at least one fluid outlet, said container member mounted for movement between a position (herein after “open position”) allowing fluid passage between and/or via said fluid outlet of said container member and said outlet to said chamber and a position (herein after “closed position”) wherein said container member seals said outlet of said chamber and
(iii) moving mechanism operatively associated with said housing and the container member for moving the container member between the open position and the closed position when the upper body portion of the housing is rotated relative to said lower body portion.

Preferably the outlet is sealed by a seal (such as an induction seal).

Preferably said container member is substantially spherical in shape.

Preferably said chamber of said housing is of a substantially complementary shape to said spherical container member.

Preferably the upper body portion and the lower body portion may engage with each other at an interface between an upper body engaging surface and a lower body engaging surface respectively.

Preferably the interface between the upper body engaging surface and the lower body engaging surface defines an interface passage.

In still a further aspect the present invention consists in a fluid switch assembly comprising;
(i) a valve housing which includes an upper body portion and a lower body portion, the upper and lower body portions defining a chamber to capture a valve member, the housing including an inlet and outlet to said chamber;
(ii) a valve member disposed within the chamber of the valve housing, said valve member mounted for movement between a position (herein after “open position”) allowing fluid passage between and/or via said inlet and said outlet and a position (herein after “closed position”) wherein said valve member seals at least one of said inlet and outlet; and
(iii) moving mechanism operatively associated with said valve housing and the valve member for moving the valve member between the open position and the closed position when the upper body portion of the housing is rotated relative to said lower body portion;
(iv) wherein the upper body portion is received substantially into a recess in the lower body portion.

Preferably when said valve member is in said open position, said valve member establishes at least one passage to allow fluid communication between said inlet and outlet.

Preferably said valve member is mounted by said chamber for rotation relative to said valve housing, about a first axis.

Preferably the moving of said valve member between the open position and the closed position by said moving mechanism operatively associated is actuated when the upper body portion of the housing is rotated relative to said lower body portion about an axis which is perpendicular to said first axis.

Preferably said inlet is provided by said lower body portion and said outlet is provided by said upper body portion.

Preferably said inlet and said outlet are provided at opposed sides of the valve housing.

Preferably said inlet and said outlet are provided at right angles to each other.

Preferably said inlet and said outlet are provided at any angle to each other.

Preferably said moving mechanism operatively associated with said valve housing and the valve member for moving the valve member between the open position and the closed position includes a cam ring mechanism.

Preferably the camming mechanism includes a cam surface provided on one of the valve member or inner surface of the chamber, and a cam follower provided on the other of the valve member or inner surface of the chamber.

Preferably the camming mechanism includes a cam surface formed on the exterior surface of the valve member and a cam pin formed on the interior surface of the upper body portion of the housing.

Preferably the camming mechanism includes a cam surface formed into the exterior surface of the valve member and a cam pin formed on the interior surface of the upper body portion of the housing.

Preferably said camming surface is a slot into which the cam pin is located.

Preferably said camming surface is a triangularly shaped slot into which the cam pin is located.

Preferably said moving mechanism operatively associated with said valve housing and the valve member for moving the valve member between the open position and the closed position is located above the rotational axis of the valve member.

Preferably said lower body portion provides said inlet to said chamber, and wherein said lower body portion is integrally formed with a container said container including an opening contiguous said inlet to said chamber.

Preferably said container is a consumer beverage container.

Preferably the upper body portion and the lower body portion engage with each other at an interface between an upper body engaging surface and a lower body engaging surface respectively.

Preferably the interface between the upper body engaging surface and the lower body engaging surface defines an interface passage.

Preferably the interface passage has an interface inlet at or in fluid communication with the chamber.

Preferably the interface passage has an interface outlet at or towards or in fluid communication with the periphery of the valve housing.

Preferably the interface passage outlet is proximate the outlet.

Preferably the interface passage outlet is proximate the inlet.

Preferably the valve housing has a proximal end and a distal end.

Preferably the valve housing is cylindrical, having a proximal end and a distal end

Preferably the interface passage outlet is proximate the outlet on a distal end of the cylindrical housing.

Preferably the interface passage outlet is proximate the inlet on a proximal end of the cylindrical housing.

Preferably the upper body portion and the lower body portion engage with each other at an interface between an upper body engaging surface and a lower body engaging surface respectively and wherein said fluid switch assembly includes a seal which engages with the valve housing to restrict the flow of fluid from operationally flowing from said chamber out through said interface.

Preferably said seal is an induction seal.

Preferably the interface between the upper body portion and the lower body portion includes a labyrinth seal.

Preferably said seal (such as an induction seal) is engaged to said upper body.

Preferably said seal (such as an induction seal) is a plastic film (one or multiple).

Preferably said seal is a plastic cap that includes an annular lip that engages said upper body portion to seal said outlet.

Preferably said seal threadingly engages with a thread formation on one of said lower and upper body portions.

Preferably said seal includes a wad seal to assist in sealing the outlet.

Preferably said upper body portions and lower body portion are attached to each other by a frangible tamper strip obstructing relative movement between the upper body portion and the lower body portion.

Preferably one or both of the upper body portion and the lower body portion are composed of a plurality of pieces in engagement with each other.

In still a further aspect the present invention consists in a flow switch suitable for regulating the flow of fluid, said flow switch comprising
(i) a valve housing which includes an upper body portion and a lower body portion, the upper and lower body portions defining a chamber to capture a valve member, the housing including an inlet and outlet to said chamber;
(ii) a valve member seated in the chamber of the valve housing, said valve member mounted for movement between a position (herein after “open position”) allowing fluid passage between and/or via said inlet and said outlet and a position (herein after “closed position”) wherein said valve member seals at least one of said inlet and outlet; and
(iii) a cam and at least one cam follower are associated with said valve housing and the valve member to effect movement of the valve member between the open position and the closed position when the upper body portion of the housing is rotated relative to said lower body portion;
wherein the lower body portion is received substantially into a recess in the upper body portion.

In yet a further aspect the present invention consists in a flow switch assembly comprising;
(i) a valve housing which includes a first body portion and a second body portion, the first body portion rotatably mounted in said second body portion, the first body portion and second body portion defining a chamber in said valve housing to capture a valve member, the first body portion defining a first opening and the second body portion defining a second opening to said chamber,
(ii) a valve member seated in the chamber of the valve housing, said valve member mounted for movement between a position (herein after “open position”) allowing fluid passage between and/or via said first and second openings and a position (herein after “closed position”) wherein said valve member prevents fluid passage between and/or via said first and second openings,
(iii) at least one cam and at least one cam follower associated with said valve housing and the valve member to effect movement of the valve member between the open position and the closed position when the first body portion of the housing is rotated relative to said second body portion.

Preferably the first body portion is located completely in said second body portion yet is accessible by a user via an aperture of said second body portion, said aperture at the surface of the second body portion extending about the first opening.

Preferably the first body portion is located in said second body portion and presents said first opening at an aperture of said second body portion, said aperture at the surface of the second body portion extending about the first opening.

Preferably the first body portion at the first opening is journaled with said second body portion at the first opening, the interface of the first body portion and second body portion at the journal region extending about the first opening.

Preferably no seams exist between said first and second body portions that exit the valve housing other than about the first opening.

Preferably an overcap is engaged to said second body portion to locate over and close said first opening.

Preferably an overcap is engaged to said second body portion to locate over and close said first opening and said aperture of said second body portion to seal any fluid connection between said cavity and the exterior of the flow switch via said aperture.

Preferably a film seal is engaged to said second body portion to extend over said first opening to close said first opening and said aperture of said second body portion to seal any fluid connection between said cavity and the exterior of the flow switch via said aperture.

In yet a further aspect the present invention consists in a flow switch assembly comprising;
(i) a valve housing which includes a first body portion and a second body portion, the second body portion includes a cavity having an aperture at a surface of said second body portion, the first body portion is rotatably mounted in the cavity of said second body portion and extends at least to said aperture to be actuable by a user for rotation relative to the second body portion, the first body portion and second body portion defining a chamber in said valve housing to capture a valve member, the first body portion defining a first opening to said chamber at and about which said aperture extends, the second body portion including a second opening to said chamber,
(ii) a valve member seated in the chamber of the valve housing, said valve member mounted for movement between a position (herein after “open position”) allowing fluid passage between and/or via said first and second openings and a position (herein after “closed position”) wherein said valve member prevents fluid passage between and/or via said first and second openings,
(iii) at least one cam and at least one cam follower associated with said valve housing and the valve member to effect movement of the valve member between the open position and the closed position when the first body portion of the housing is rotated relative to said second body portion.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The term ‘comprising’ as used in this specification means ‘consisting at least in part of’, that is to say when interpreting statements in this specification which include that term, the features, prefaced by that term in each statement, all need to be present but other features can also be present.

### BRIEF DESCRIPTION OF THE DRAWINGS

Preferred forms of the present invention will now be explained with reference to the drawings in which;

FIG. 1 is a perspective view of part of a valve assembly of the present invention,

FIG. 2 is an exploded view of the valve assembly of FIG. 1,

FIG. 3 is an exploded view in an alternative direction and of slight variation to the valve assembly of FIG. 1,

FIG. 3A illustrates the fluid switch of FIG. 1 engaged with a consumer beverage container and wherein the valve member is shown in an open condition,

FIG. 3B shows the valve member positioned intermediate of a fully open and fully closed condition of the valve assembly,

FIG. 3C illustrates the valve member in a condition where the assembly is fully closed,

FIG. 4 is a perspective view of the assembly of FIG. 1 engaged with a seal (such as an induction seal),

FIG. 5 is an exploded view showing the components of the assembly of FIG. 4,

FIG. 6 illustrates a fluid switch engaged with a seal (such as an induction seal),

FIG. 7 is a side view of a fluid switch of the present invention wherein an alternative form of seal (such as an induction seal) is provided,

FIGS. 8-10 shows yet a further alternative, and

FIG. 11 shows a variation of the valve wherein no inlet is provided and where the passage acts as a reservoir instead.

FIG. 12 is a perspective view of part of a valve assembly of the present invention,

FIG. 13 is an exploded view of the valve assembly of FIG. 1,

FIG. 14 is an exploded view in an alternative direction and of slight variation to the valve assembly of FIG. 1,

FIG. 14A illustrates the flow switch of FIG. 1 engaged with a consumer beverage container and wherein the valve member is shown in an open condition,

FIG. 14B shows the valve member positioned intermediate of a fully open and fully closed condition of the valve assembly,

FIG. 14C illustrates the valve member in a condition where the assembly is fully closed,

FIG. 15 is a perspective view of the assembly of FIG. 1,

FIG. 16 is an exploded view showing the components of the assembly of FIG. 4,

FIG. 17 illustrates a flow switch including a seal,

FIG. 18 is a flow switch wherein an alternative form of seal is provided,

FIG. 19 shows a variation of the valve wherein no inlet is provided and where the passage acts as a reservoir instead,

FIG. 20 is a side view of a valve member illustrating an alternative configuration of lugs and camming pins to that shown in the FIGS. 12-14,

FIG. 21 illustrates the same valve member as shown in FIG. 20, but wherein the valve member has been rotated,

FIG. 22 is a perspective view of a valve member showing longitudinal and latitudinal designations for the purposes of illustrating the dynamics,

FIG. 23 is an end view of a valve member looking onto the pole for the purposes of illustrating the dynamics of the valve member,

FIG. 23a is a view from another side of the valve member of FIG. 23 illustrating a less desired positioning of the cam pin relative to the valve member 5,

FIG. 23b is an end view like the end view shown in FIG. 23 illustrating the cam lobes of the valve member 5,

FIG. 23c shows a further variation,

FIG. 24 illustrates a variation to the cam pin arrangement where the cam pin consists of two discrete elements that interact with cam lobes of the valve member,

FIG. 25 illustrates a valve member wherein a cam pin of a different configuration to that shown with reference to the preferred forms of the invention is provided,

FIG. 26 is a view of a valve member wherein the cam lobes of the upper body portion are of a curved configuration,

FIG. 27 is a view of a valve member and showing cam lobes of a circular configuration, and

FIG. 28 shows a variation wherein the cam lobes are surfaces that are parallel each other.

FIG. 29 shows a cutaway cross section view of a flow switch in which the upper body portion is substantially received into a recess in the lower body portion.

FIG. 30 shows a cutaway cross section view of a flow switch in which the lower body portion is substantially received into a recess in the upper body portion;

FIG. 31 shows a cutaway cross section view of a flow switch in which the lower body portion consists of two members in locking engagement with each other, and having a frangible tamper strip; and

FIG. 32 shows a cutaway cross section assembly side view of another embodiment of a flow switch in which the lower body portion consists of two members in locking engagement with each other, and having a frangible tamper strip.

### DETAILED DESCRIPTION OF THE INVENTION

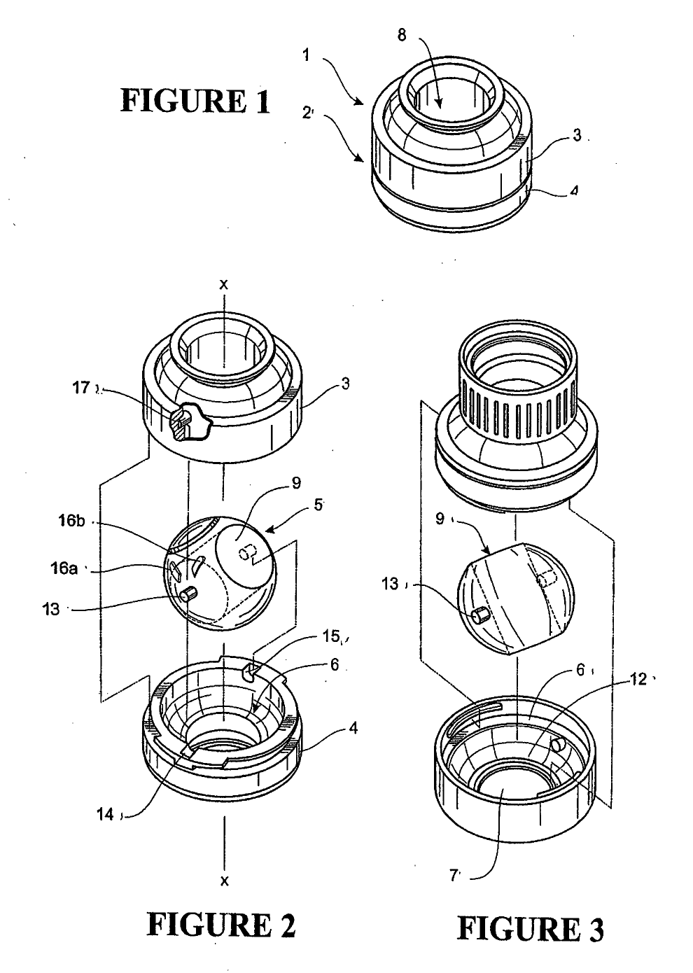

Referring now to the drawings wherein like reference numerals identify similar structural elements or features of the subject invention, there is illustrated in FIG. 1 a fluid switch 1, without a seal (such as an induction seal).

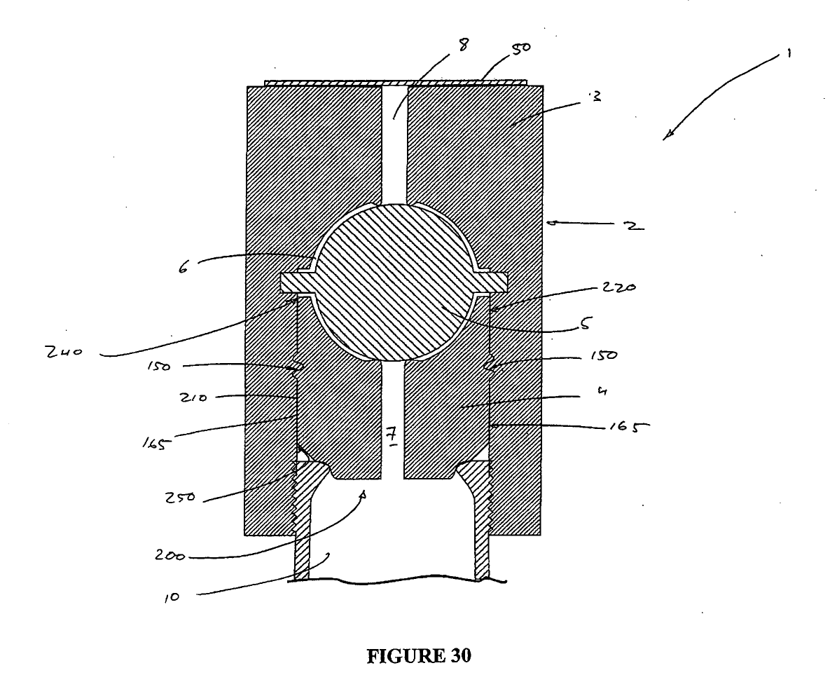

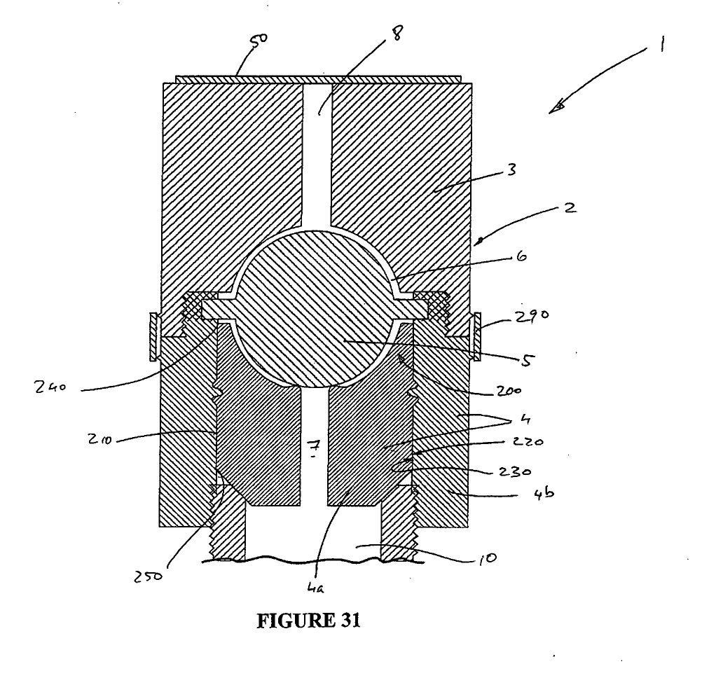

The fluid switch assembly 1 includes, inter alia, a valve housing 2 having an upper body portion 3 and a lower body portion 4 and a valve member 5 preferably of a spherical shape. The upper and lower body portions 3/5 of the housing 2 define an internal cavity 6 to capture the valve member 5. The fluid switch assembly may have a central axis “X”. The housing 2 preferably also has inlet and outlet ports 7 and 8 respectively, formed in the lower and upper body portions 4 and 3 respectively. These are axially aligned with the central axis “X”, but with respect to the present invention this need not necessarily be so (see for example, FIGS. 30 and 31 for an illustration of alternatives).

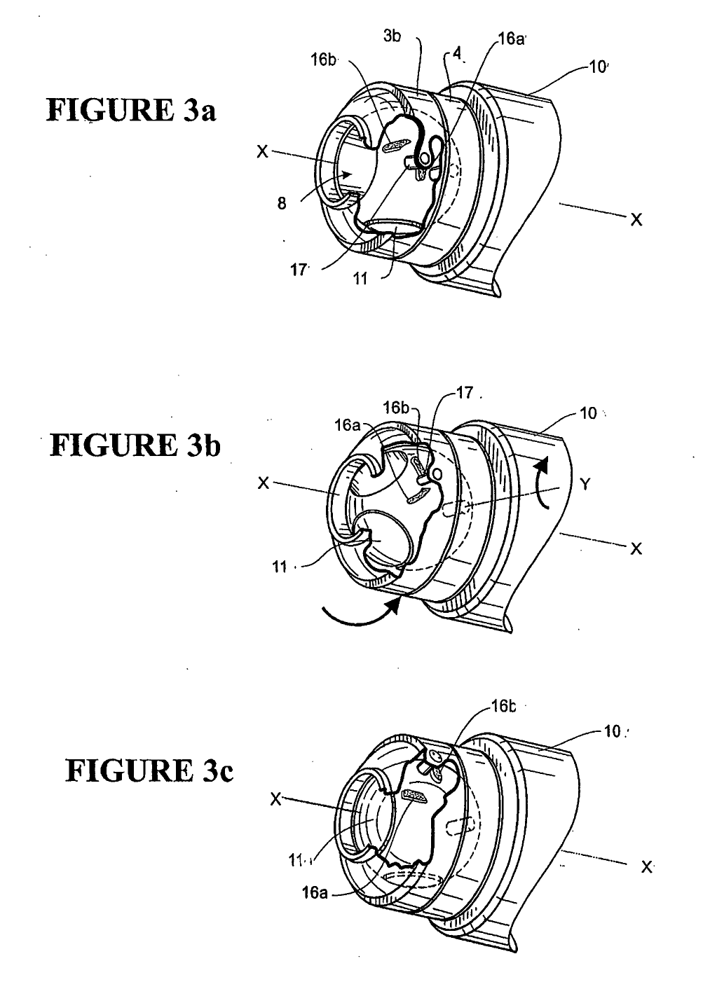

The valve member 5 is seated within the internal cavity 6 of the valve housing 2 and has a passage 9 extending therethrough. The valve member 5 is mounted for movement within the internal cavity 6 of the housing 2 between an open position and a closed position. FIG. 3A illustrates fluid switch assembly 1 in the open position; wherein the passage 9 of the valve member 5 allows fluid communication between the inlet port 7 and the outlet port 8 of the valve housing 2. In a like manner, FIG. 3C illustrates the fluid switch assembly 1 in the closed position; wherein the passage 9 of the valve member 5 is positioned relative to the inlet and outlet ports 7/8 of the valve housing 2 to prevent flow of fluid between the ports. FIG. 3B, shows detail of the valve assembly 1 in an intermediate position.

With continuing reference to FIGS. 3A through 3C, valve member 5 moves between the open position and the closed position when the upper body portion 3 of the housing is rotated about the central axis “X” with respect to the lower body portion 4. The valve member 5 is mounted for rotation within the interior chamber about an axis “Y” (see FIG. 3B) extending preferably perpendicular to the central axis “X” defined by the upper and lower body portions 3, 4 of the valve housing 2.

The valve member 5 may include a sealing surface 11 which is adapted for sealing engagement with annular valve seat 12 formed in the housing 2 when the valve is in a closed position.

Two, preferably diametrically opposed, pivot pins 13 (only one pin is shown in FIG. 2) extend radially outwardly from the surface of the valve member 5 for accommodation within diametrically opposed recesses 14 and formed in a lower body portion 4 of the housing 2 to facilitate the rotation of the valve member 5.

A camming or driving mechanism is operatively associated with the valve housing 2 and the valve member 5 for moving the valve member 5 between the open position of FIG. 3A and the closed position of FIG. 3C. The camming mechanism includes cam lobes 16A, 16B formed on the exterior surface of the valve member 5 and a cam pin (protrusion or projection or recess) which extends radially inwardly from the interior surface of the upper body portion 3 of the housing 2 to cooperate with the cam lobes. The interaction therebetween allows for movement of the valve member between open and closed conditions upon relative rotation of the upper and lower body portions.

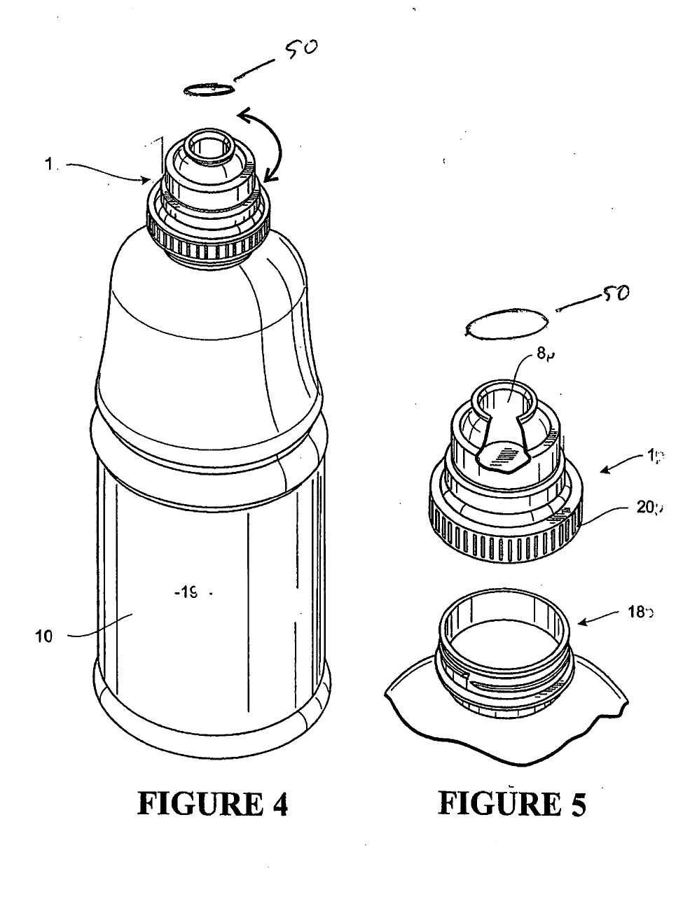

With reference to FIGS. 4 and 5 there is illustrated a fluid switch assembly engaged with a beverage container 10. The fluid switch assembly 1 as shown in FIGS. 4 and 5, can be threadingly or engaged to a beverage container 10 as a result of the beverage container providing a spout 18. The spout is for example integrally formed with the container portion 19. The beverage container 10 may be a blow moulded or injection moulded (or similar) plastic container and may be of a size sufficient to contain beverages such as water or flavoured water or soft drink or the like. The container may indeed also include carbonated liquid. The fluid switch assembly 1 may include a collar 20 which includes an internal thread which is engageable onto an external thread of the spout 18. A sealing engagement between the valve assembly 1 and the spout 18 can be established so that contents of the beverage container 10 can pass through the spout 18 and be displaced out through the fluid switch assembly 1. Also shown is a form of seal (such as an induction seal) 50.

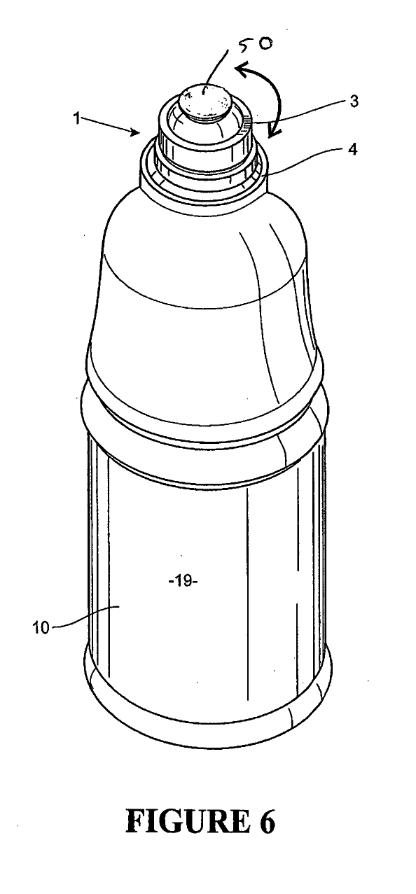

With reference to FIG. 6 there is shown a seal (such as an induction seal) 50 engaged to the valve assembly.

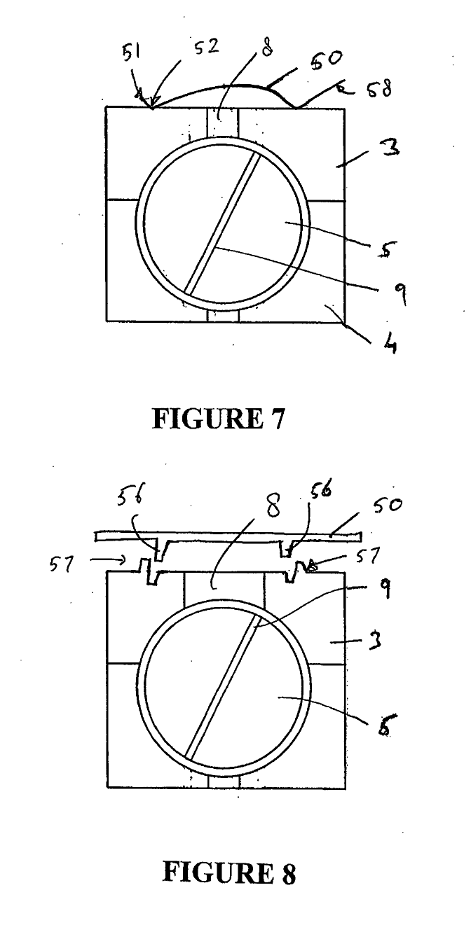

The seal (such as an induction seal) may be heat sealed to the upper body portion 3 in a manner that can still allow for peeling of the seal (such as an induction seal) 50 to occur. The seal (such as an induction seal) 50 may be made of a plastic film material that has properties or can be modified to establish properties to allow for it to be sealed to the material of the valve. With reference to FIG. 7, there is shown a seal (such as an induction seal) 50 that has been sealed at or towards its perimeter 51 by heat sealing 52, to the upper body portion 3. Such sealing is an enclosed seal around the outlet 8 such that it prevents any fluid leakage from the outlet 8 that might pass through the valve of the present invention even if the valve member 5 is in a closed condition. The seal (such as an induction seal) 50 may alternatively or in addition, be adhesively bonded to the upper body portion 3.

In an alternative form as shown with reference to FIG. 8, the seal (such as an induction seal) 50 may be in the form of a cap that can engage with the upper body member 3 in an appropriate manner to seal about the outlet 8. The seal (such as an induction seal) 50 of FIG. 8 may be of a plastic material and may include ridges or relief 56 which can locate with complementary shaped ridges or reliefs 57 of the upper body member 3. As seen with reference to FIG. 8, the seal (such as an induction seal) 50 includes upstands 56 which can locate into a recess of the upper body member 3. The recess is preferably of a circular plan shape and the upstand 56 of the seal (such as an induction seal) 50 is likewise of a circular plan shape. The upstands 56 can locate into the recess 57 so as to create a seal about the opening 8. Any pressure build up within a space between the outlet 8 and the seal (such as an induction seal) 50 can result in the upstands 56 from being displaced to enhance the seal of the seal (such as an induction seal) 50. The upstands 56 may be of a flexible kind to allow for displacement to occur upon the application of a fluid pressure there against. Such fluid pressure can enhance the sealing ability. The seal (such as an induction seal) 50 in the form of a cap as shown in FIG. 8 may be made of a suitable plastics material and may have additional modifications and surface relief provided. The seal (such as an induction seal) of the form as shown in FIG. 7 may include a peel tab 58 to allow for the seal (such as an induction seal) 50 to be conveniently pulled away from the upper housing 3.

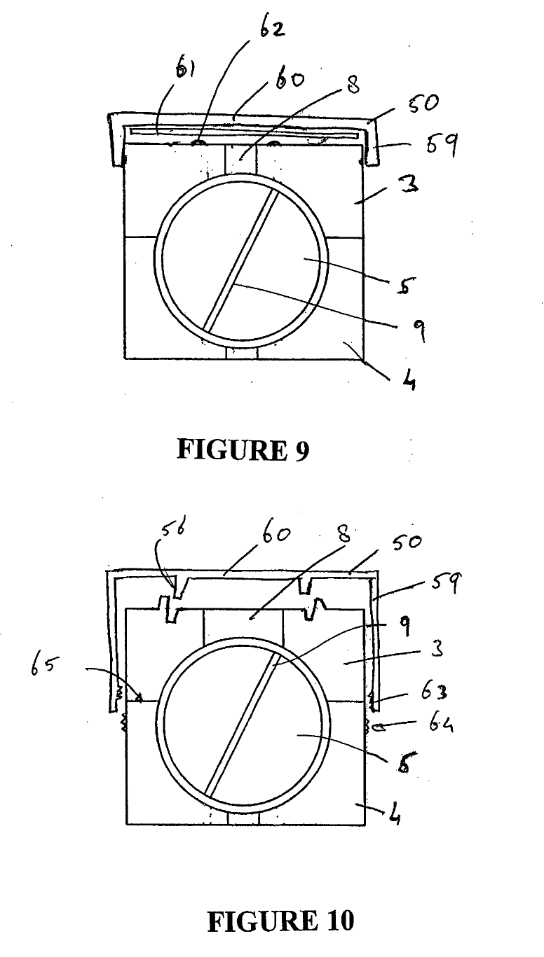

With reference to FIG. 9, there is shown a seal (such as an induction seal) which may snap fit over or with the upper body portion 3. The seal (such as an induction seal) 50 of FIG. 9 may include a skirt portion 59 and an end portion 60. The skirt portion 59 may locate over the upper housing 3 as shown in FIG. 9. Within the space between the upper housing 3 and the seal (such as an induction seal) 50 may be a wad seal 61 that facilitates sealing of the outlet 8. The upper housing 3 may include an annular ridge 62 to engage with the wad seal 60 and thereby establish a seal about the opening 8.

With reference to FIG. 10, there is shown a seal (such as an induction seal) 50 which is a cap that includes a skirt 59 and an end portion 60. The skirt may include threads 63 which can threadingly engage with threads 64 of the lower body portion 4 of the valve of the present invention. Rotation of the seal (such as an induction seal) 50 relative to the lower body portion 4 can allow for the seal (such as an induction seal) 50 to be threadingly engaged to the valve and simultaneously drive and locate and thereby seal, upstands 56 with the upper body portion 3 of the valve to thereby seal the outlet 8. The seal (such as an induction seal) 50 as shown in FIG. 10 will also seal any leakage that may include between the interface 65 of the upper body portion 3 and lower body portion 4.

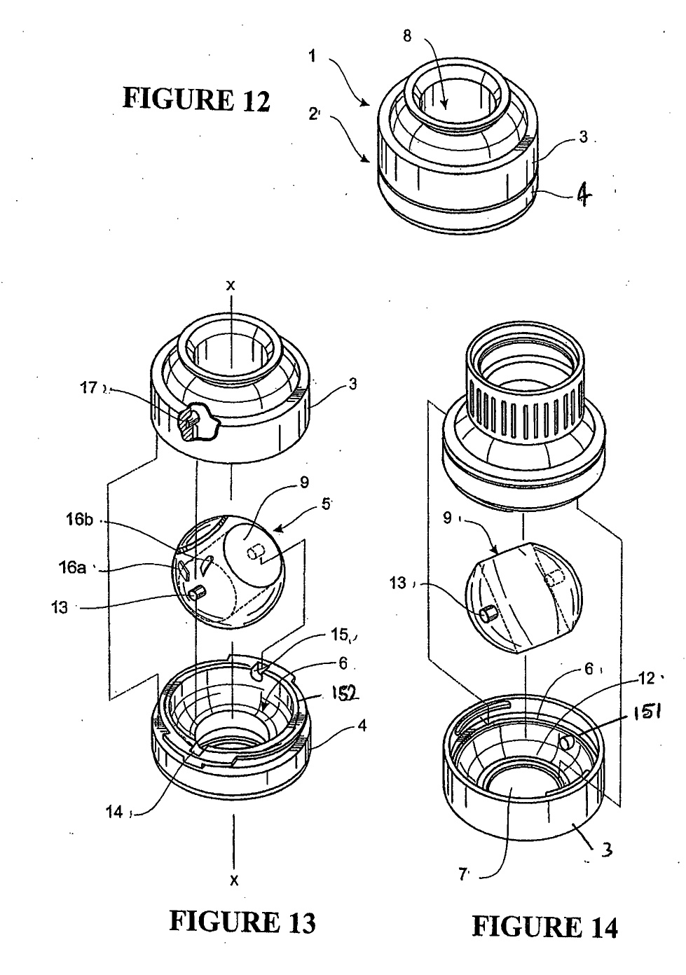

In FIG. 12 is illustrated a flow switch assembly 1.

The flow switch assembly 1 includes, inter alia, a valve housing 2 having an upper body portion 3 and a lower body portion 4 and a valve member 5 preferably of a spherical shape. The upper and lower body portions 3/5 of the housing 2 define an internal cavity 6 to capture the valve member 5. The flow switch assembly 1 may have a central axis “X”. The housing 2 preferably also has inlet and outlet ports 7 and 8 respectively, formed in the lower and upper body portions 4 and 3 respectively. These are axially aligned with the central axis “X”, but with respect to the present invention this need not necessarily be so. Reference is made to the description of the invention of PCT/NZ06/000087 which is hereby incorporated by way of reference.

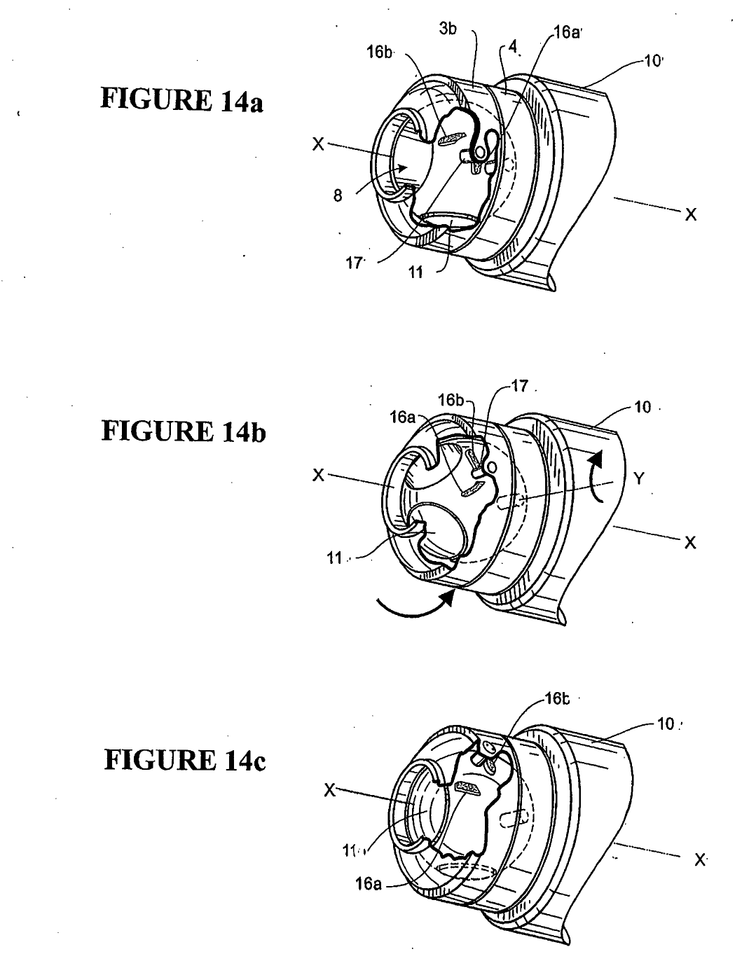

The valve member 5 is seated within the internal cavity 6 of the valve housing 2 and has a passage 9 extending therethrough. The valve member 5 is mounted for movement within the internal cavity 6 of the housing 2 between an open position and a closed position. FIG. 14A illustrates flow switch assembly 1 in the open position; wherein the passage 9 of the valve member 5 allows fluid communication between the inlet port 7 and the outlet port 8 of the valve housing 2. In a like manner, FIG. 14C illustrates the flow switch assembly 1 in the closed position; wherein the passage 9 of the valve member 5 is positioned relative to the inlet and outlet ports 7/8 of the valve housing 2 to prevent flow of fluid between the ports. FIG. 14B, shows detail of the valve assembly 1 in an intermediate position.

With continuing reference to FIGS. 14A through 14C, valve member 5 moves between the open position and the closed position when the upper body portion 3 of the housing is rotated about the central axis “X” with respect to the lower body portion 4. The valve member 5 is mounted for rotation within the interior chamber about an axis “Y” (see FIG. 14B) extending preferably perpendicular to the central axis “X” defined by the upper and lower body portions 3, 4 of the valve housing 2.

The valve member 5 may include a sealing surface 11 which is adapted for sealing engagement with annular valve seat 12 formed in the housing 2 when the valve is in a closed position.

Two, preferably diametrically opposed, pivot pins 13 (only one pin is shown in FIG. 13) extend radially outwardly from the surface of the valve member 5 for accommodation within diametrically opposed recesses 14 and formed in a lower body portion 4 of the housing 2 to facilitate the rotation of the valve member 5. This configuration may be reversed where the recesses are of the upper body portion and cam pin is on the lower body portion.

A camming or driving mechanism is operatively associated with the valve housing 2 and the valve member 5 for moving the valve member 5 between the open position of FIG. 14A and the closed position of FIG. 14C. The camming mechanism includes cam lobes 16A, 16B formed on the exterior surface of the valve member 5 and a cam pin 17 (protrusion or projection or recess) which extends radially inwardly from the interior surface of the upper body portion 3 of the housing 2 to cooperate with the cam lobes. The interaction therebetween allows for movement of the valve member between open and closed conditions upon relative rotation of the upper and lower body portions.

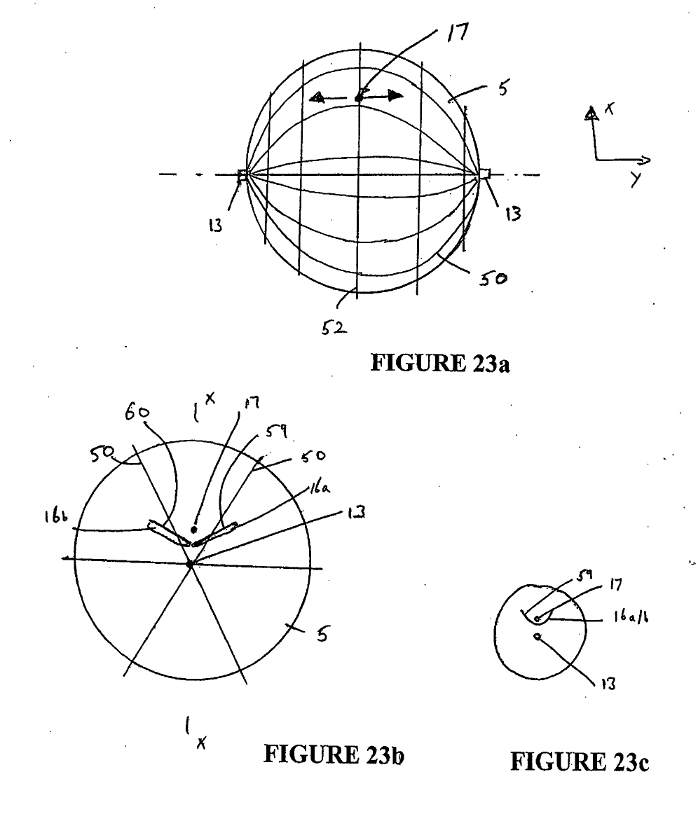

With reference to FIG. 23 there is shown a reference to the valve assembly including the valve member 5 rotating about the axis YY supported by the pivot pins 13. Drawn on the spherical valve member 5, are lines of longitude 50 that extend between the poles at the pivot pins 13. The sphere also includes lines of latitude 51 including the equator line 52 midway between the opposed poles.

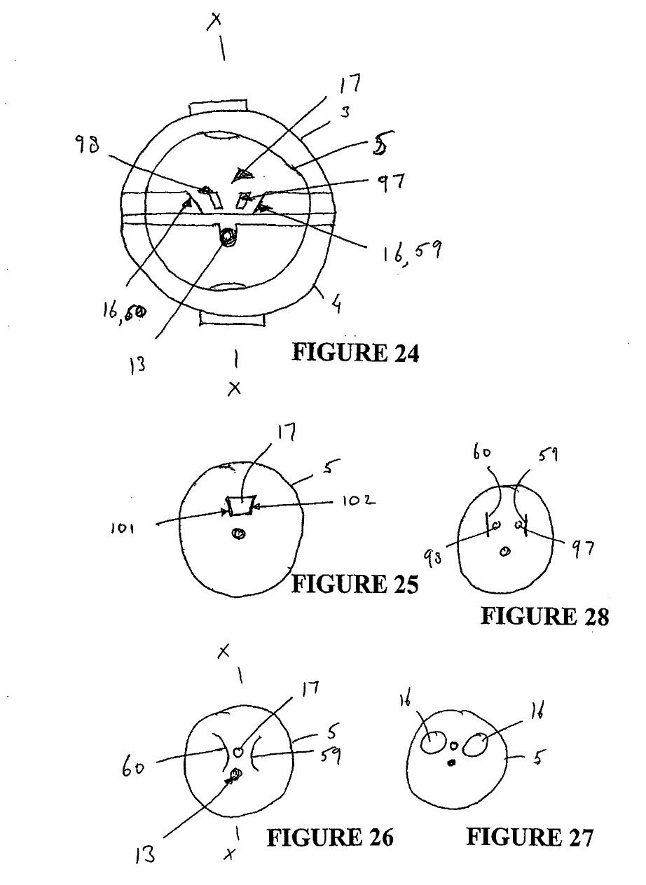

As also shown in FIG. 23 is an upper body portion 3 that is shown in an exploded view relative the valve member 5 and wherein it is positioned for rotation about the axis XX. Shown on the upper body portion 3 are its lines of longitude 53 and its lines of latitude 54. Also shown is the cam pin 17 mounted by the upper body portion 3 and mounted for movement parallel to the latitudinal lines 54. In the preferred form where the XX and YY axes are perpendicular to each other, the lines of latitude 54 of the upper body portion 3 lie parallel to the YY axis. Likewise the lines of latitude 51 of the valve member 5 lie parallel to the XX axis. Positioning of the cam pin 17 of the upper body portion 3 is preferably such that it is located proximate the axis YY and proximate the poles at pivot pins 13. Interaction of the cam pin with the cam lobes at this region results in favourable mechanical advantage to be provided during the rotation of the upper body portion 3 about the axis XX with the valve member 5. With reference to FIG. 24, it can be seen that a movement of the cam pin 17 along a latitudinal line or plane of the upper body portion 3 between its left most limit of movement at 17L and its right most limit of movement at 17R results in the cam pin 17 traversing across a higher density of longitudinal lines 50 of the valve member 5. In other words, for the same arc traveled by the pin 17 along one of its latitudinal lines the pin will cross more lines of longitude at this more preferred location of the pin, than at an arc that is further from the pole 13 towards the equator 52. Also the further the cam pin 17 is positioned towards the pole 56 of the upper body portion 3, the less the mechanical advantage will become. In the preferred form the cam pin 17 has its limits of movement provided on either side of the plane sitting in the X-X and Y-Y axes (i.e. the XY plane).

FIG. 25a illustrates a positioning of the cam pin 17 in a undesirable position. Referring to FIG. 25a in this position the cam pin is located proximate the equator 52 of the valve member 5 and moves parallel to the YZ plane (i.e. in a latitudinal line 54 of the upper body portion 3 but only on one side of the XY plane of the valve housing 5). Such positioning of the cam pin is undesirable as it does not traverse a high density of longitudinal lines 50 of the valve member 5 to effect favourable mechanical advantage. Other inherent problems may also arise.

Although not shown in FIGS. 23 and 24, the cam lobes present a reaction surface that may each extend parallel a line of longitude 50 of the valve member. However alternatively the reaction surface may traverse across the line of longitude of the valve member 5. The reaction surface of a cam lobe need not be a straight surface but may be curved yet still allow for the cam pin 17 to react therewith for the purposes of displacing and rotating the valve member 5 about the YY axis. Such a variation is for example shown with reference to FIG. 25c, where the cam lobes 16a and 16b have reaction surfaces 59 and 60 respectively that each traverse a respective line of longitude 50 of the valve member 5.

Whilst reference herein is made to longitudinal and latitudinal lines having direct reference to a spherical valve element, it will be appreciated that other forms of valve elements will have similar principles at work given that such will still have two poles.

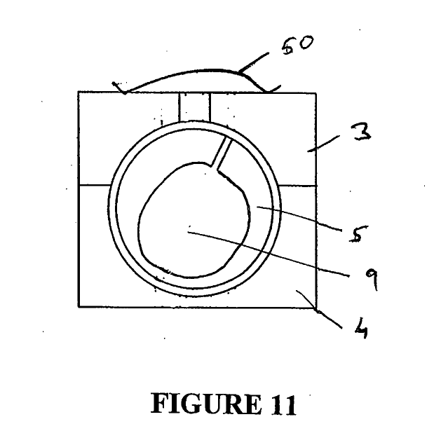

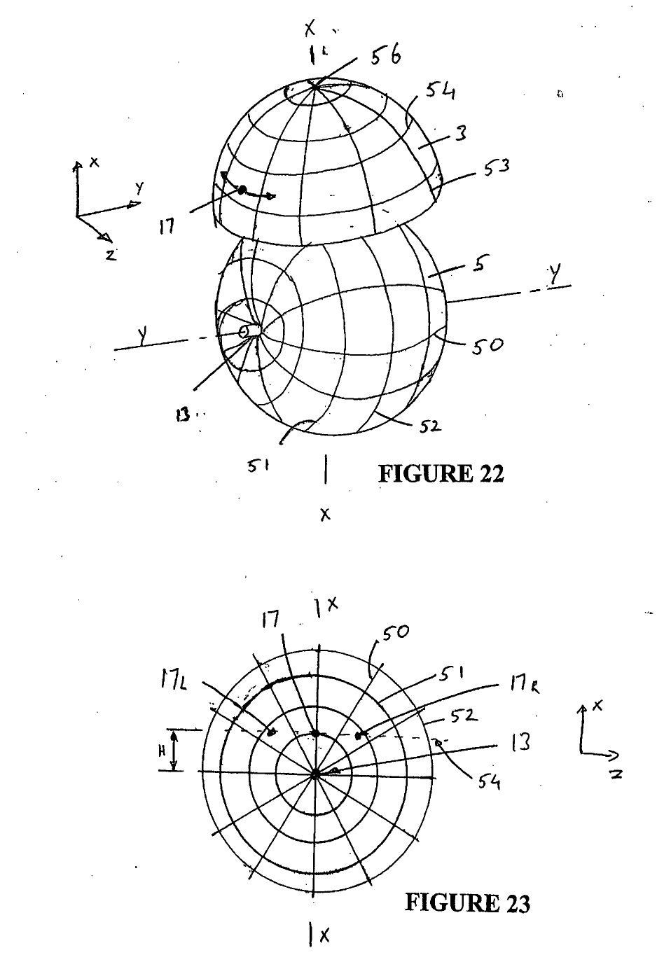

A further variation to the cam lobes is shown with reference to FIGS. 21 and 11 wherein the reaction surfaces 59 and 60 are parallel each other and intermediate of which the cam pin 17 is placed. FIG. 22 illustrates the cam pin 17 being displaced to the left side of the XY plane thereby having rotated the valve member 5 in a anticlockwise direction about the YY axis. The reaction surface 60 of the cam lobe 16b has interacted with the cam pin 17 in rotating the valve in the anticlockwise direction. Rotation of the cam pin 17 about the XX axis in the opposite direction will result in a returning of the valve member 5 to the position shown in FIG. 21. The return rotation will result in the cam pin 17 engaging with the reaction surface 59 of the cam lobe 16a. A close positioning of the two reaction surfaces 59 and 60 when the cam pin is at its extremes of rotation, will result in little or no play existing between the interaction of the cam pin 17 with the reaction surfaces 60 and 59. Such play can be minimised by a positioning of the cam pin 17 proximate more the pivot pins 13 where for example the cam lobes are in a V-shaped configuration. They may also be of a U-shaped configuration. The reaction surfaces are preferably straight when locking onto the valve but they may also be curved other than preferably also being curved to follow the surface of the preferred spherical valve member.

Alternatively, an appropriate positioning of the V-shaped cam lobes such that their reaction surfaces traverse across the lines of longitude 50 or by having cam lobes that are of or tend towards a parallel configuration as shown in FIGS. 21 and 22 may have similar effect.

However one of the potential disadvantages of proximate parallel cam lobes as shown in FIGS. 21 and 22 is for example with reference to FIG. 22. Upon the return of the cam pin 17 to rotate the valve member 5 in a clockwise direction, the angle of incidence of the movement of the cam pin 17 (parallel to the ZZ plane) with the reaction surface 59, may be an angle that is too shallow 15, and may result in jamming or an un-rotatable valve member. The angle T as shown in FIG. 22 is relatively large and therefore a shallow angle of contact is made between the reaction surface 59 and the cam pin 17 upon the movement of the cam pin 17 to rotate the valve member 5 in the clockwise direction. The further that the angle tends towards 90 degrees or zero degrees and away from 180 degrees, the less likely that such jamming will occur.

A person skilled in the art will realise that variations to this preferred configuration can occur including where the XY plane and the ZY planes are not perpendicular of each other.

The degree of play may be dependent on the separation of the reaction surfaces at the latitude of the upper body portion at where the cam pin is mounted. Where the surfaces are of a V-shaped configuration, the closer that the cam pin is mounted towards the apex of the V, the less play there will be. The apex of the V (whether or not the surfaces in fact touch each other) may be at the pole of the valve member or may terminate at a latitude of the valve member away from the pole.

With reference to FIG. 26 there is shown a valve member 5 that carries a cam pin 17 that consists of two elements 97 and 98. In effect the cam pin 17 in this configuration consists of such two discrete elements 97 and 98 that each interact with respective cam lobes 16 that each define a reaction surface 59 and 60 for a respective element 97 and 98. In the example shown with reference to FIG. 26, rotation of the lower body portion 4 relative to the upper body portion 3 will result in the displacement of the cam lobes 16 about the rotational axis XX until, depending on the direction of rotation, they make contact with the elements 97/98 of the cam pin 17.

A variation to the configuration shown in FIG. 26 is where one of the elements 97 is provided proximate more one of the pivot pins 13 of the valve member 5 and another of the elements of the cam pin 17 is provided proximate more the opposite pivot pin (not shown) of the valve element 5 and wherein respective cam lobes are presented for interaction with the elements 97/98.

With reference to FIG. 27 there is shown a valve member 5 wherein the cam pin 17 is for example of a trapezoidal shape wherein its interactive surfaces 101 and 102 are provided in a non parallel configuration for interaction with respective reaction surfaces (not shown) of the cam lobes of the upper body portion 3. Here it can be seen that the cam pin 17 need not necessarily be of a circular plan shape as has hereinbefore been described.

With reference to FIG. 28 there is shown a valve member 5 having a cam pin 17 presented for interaction with reaction surfaces 59 and 60 that are of a arcuate form. The reaction surface 59 and 60 are presented in the path of travel of the cam pin 17 about the XX axis independent from the upper body portion 3 so that upon the rotation of the upper body portion 3 about the axis XX, the reaction surfaces 59 and 60 interact with the cam pin 17 to effect the rotation of the valve member 5 about its pivot pins 13.

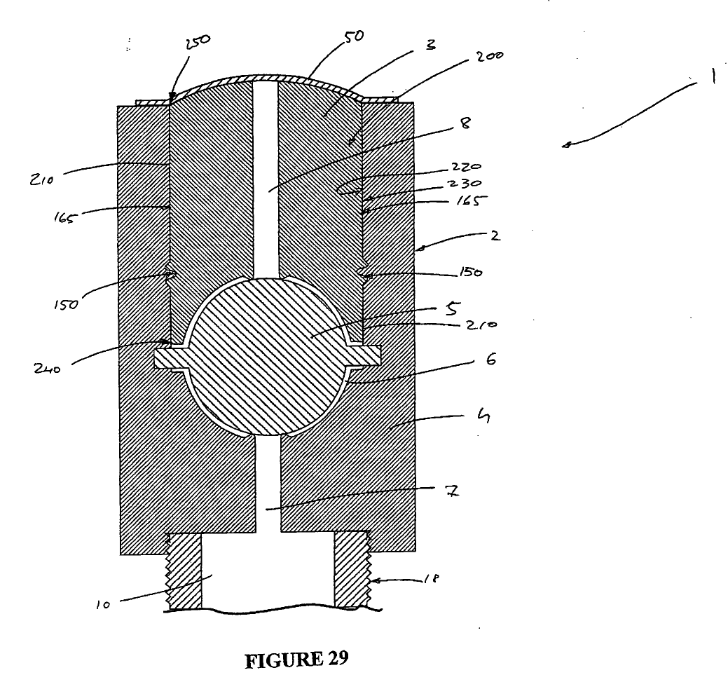

FIG. 29 illustrates a variation wherein the reaction surfaces are defined by the cam lobes 16 that are of a circular or oval shape when looking down onto the surface of the valve member 5.

FIG. 30 is a variation wherein the reaction surfaces 59 and 60 are presented by the upper body portion 3 in a substantially parallel condition but with significant separation.

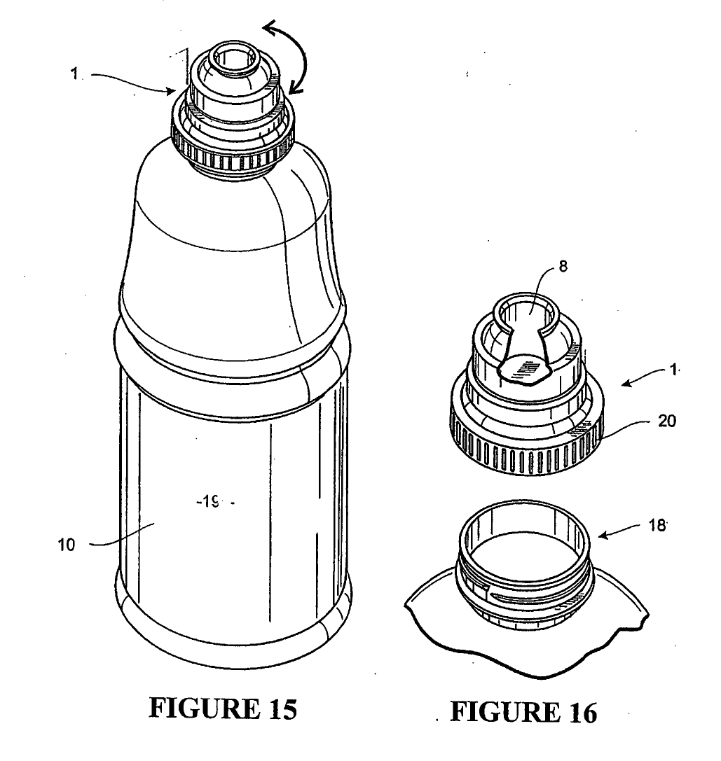

With reference to FIGS. 15 and 16 there is illustrated a flow switch assembly engaged with a beverage container 10. The flow switch assembly 1 as shown in FIGS. 15 and 16, can be threadingly engaged to a beverage container 10 as a result of the beverage container providing a spout 18. The spout is for example integrally formed with the container portion 19. The beverage container 10 may be a blow moulded or injection moulded (or similar) plastic container and may be of a size sufficient to contain beverages such as water or flavoured water or soft drink or the like. The container may include carbonated liquid. The flow switch assembly 1 may include a collar 20 that includes an internal thread which is engageable onto an external thread of the spout 18. A sealing engagement between the valve assembly 1 and the spout 18 can be established so that contents of the beverage container 10 can pass through the spout 18 and be displaced out through the flow switch assembly 1.

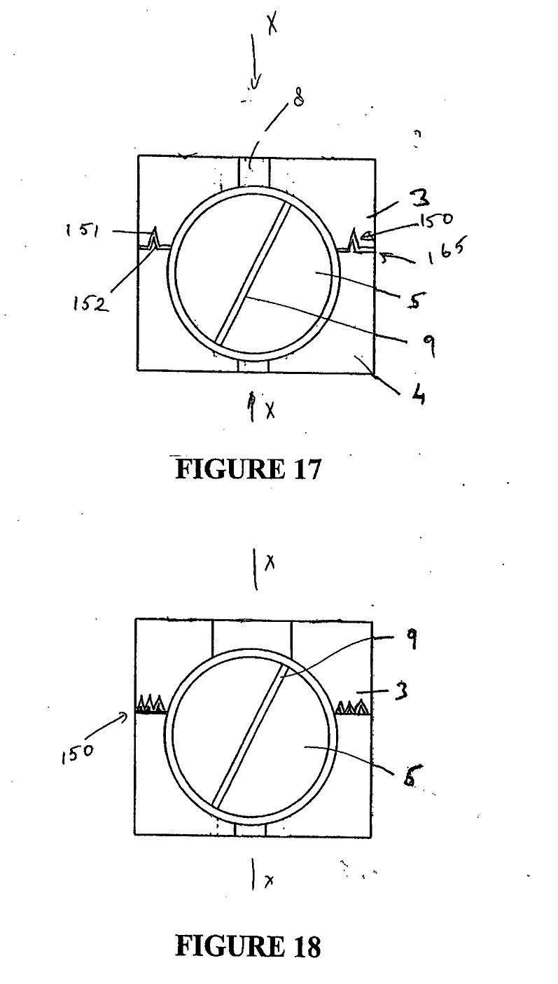

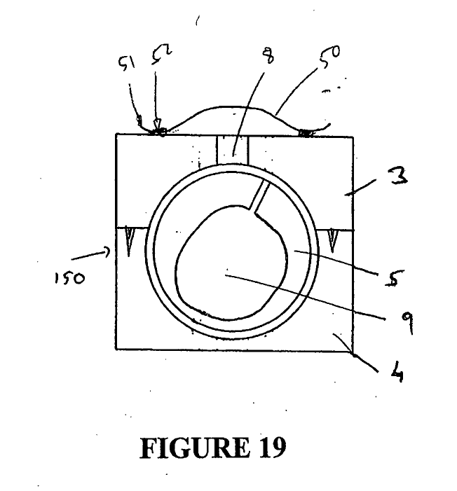

With reference to FIG. 17 there is shown a seal (such as a labyrinth seal) 150 of the valve assembly. The seal aims to reduce leakage of fluid from the chamber in which the valve is located through the interface between the upper and lower housing to the outside of the flow switch assembly 1.

The labyrinth seal 150 is preferably provided at contiguous surfaces of the upper housing 3 and lower housing 4. The seal is preferably a labyrinth seal that is defined by at least one upstand or recess defined in a contiguous surface of the upper housing 3 adjacent which at least one corresponding upstand or recess of the contiguous surface of the lower housing 4 can locate in a complementary manner. The labyrinth seal is with reference to FIG. 17, preferably provided at an interface 165 of the upper and lower housing. With reference to FIGS. 13 and 14, one part of the labyrinth seal 151 is shown forming part of the upper housing 3 and the other part of the labyrinth seal 152 is shown to form part of the lower housing 4. Location of one part of the labyrinth seal 151 with the other part of the labyrinth seal 152 occurs by bringing together of the upper and lower housing in the axial direction XX. This allows for convenient assembly of the upper and lower housing with each other and simultaneously the establishing of the labyrinth seal. The labyrinth seal aims to provide a restriction to the flow of any fluid within the cavity. Each of the relief or upstand of the labyrinth seal 150 is arcuate or circular in plan ( locking in the X axis direction) and is concentric about the axis XX. This ensures that when the upper housing 3 relative to the lower housing 4 rotates about the axis XX such rotational movement is not restricted by the labyrinth seal 150. At least one and preferably both of the or each of the upstands and recesses of the labyrinth seal 150 are substantially continuous about the XX axis. However intermittency may be provided in one of the upstand and recess.

With reference to FIG. 17 it can be seen that only one upstand and corresponding recess is provided to define the labyrinth seal. With reference to FIG. 18 a plurality of upstands and recesses are provided to define the labyrinth seal 150. The more upstands and recesses provided the greater the resistance to displacement of any fluid in the chamber to the outside of the valve housing will occur.

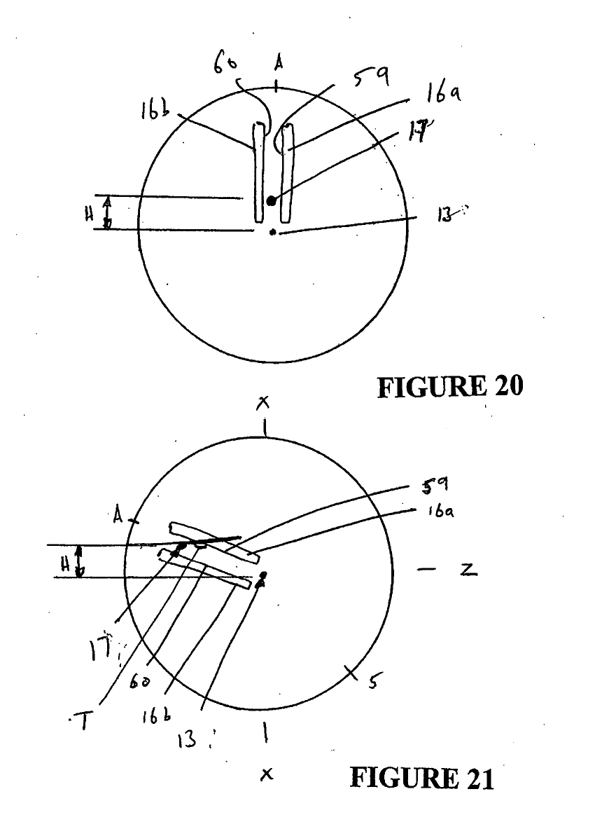

With reference to FIG. 20, there is shown an optional overcap 50 which may snap fit or threadingly engage over or with the upper body portion 3. The cap 50 FIG. 20 may include a skirt portion 59 and an end portion 160. The skirt portion 159 may locate over the upper housing 3 as shown in FIG. 20 to seal the interface 165 between the upper and lower housing. The upper housing 3 may include an annular ridge 162 to receive an annular lip 156 and thereby also establish a seal about the opening 8.

The skirt may include threads 163 which can threadingly engage with threads 164 of the lower body portion 4 of the valve of the present invention. Rotation of the cap 158 relative to the lower body portion 4 can allow for the cap 158 to be threadingly engaged to the valve and simultaneously drive and locate and thereby seal, lip 156 with the upper body portion 3 of the valve to thereby seal the outlet 8. The cap 158 as shown in FIG. 20 will also seal any leakage that may include between the interface 165 of the upper body portion 3 and lower body portion 4 when the cap 158 is engaged with the lower housing.

A flow switch is shown in FIG. 31, wherein the the upper body portion 3 is substantially received into a recess 200 in the lower body portion 4. The lower body portion 4 is adapted to engage with the spout 18 of a beverage container 10. The upper body portion 3 and the lower body portion 4 engage with each other at the interface 165 between an upper body engaging surface 220 on the upper body portion 3 and a lower body engaging surface 230 on the lower body portion 4 respectively. The interface 165 between the upper body engaging surface 220 and the lower body engaging surface 230 defines an interface passage 210, having an interface inlet 240 and an interface outlet 250. In FIG. 13 the interface inlet 240 is disposed at the chamber 260 which is defined by the valve housing 2. The interface passage 210 has an interface outlet 270 proximate the outlet 8. As shown in FIG. 31, the interface outlet 250 and the outlet 8 are both covered by the induction seal.

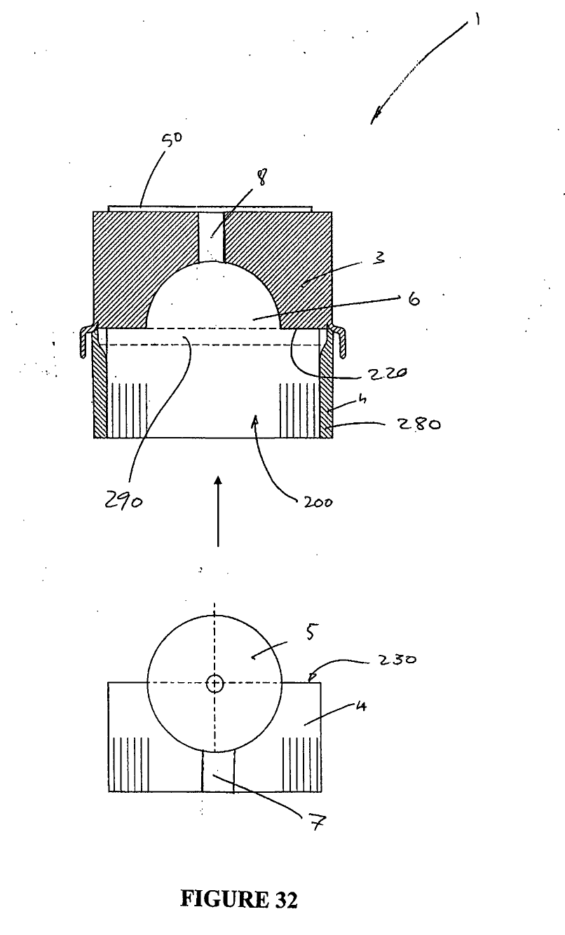

A flow switch is shown in FIGS. 31 and 32, wherein the upper body portion 3 is substantially received into a recess 200 in the lower body portion 4. The lower body portion 4 is adapted to engage with the spout 18 of a beverage container 10. The upper body portion 3 and the lower body portion 4 engage with each other at the interface 165 between an upper body engaging surface 220 on the upper body portion 3 and a lower body engaging surface 230 on the lower body portion 4 respectively. The interface 165 between the upper body engaging surface 220 and the lower body engaging surface 230 defines an interface passage 210, having an interface inlet 240 and an interface outlet 250. In FIG. 31 the interface inlet 240 is disposed at the chamber 260 which is defined by the valve housing 2. The interface passage 210 has an interface outlet 250 proximate the outlet 8. As shown in FIG. 29, the interface outlet 250 and the outlet 8 are both covered by the induction seal.

As shown in FIGS. 31 and 32, the lower body portion 4 is substantially received into a recess 200 in the upper body portion 3. In this configuration, the upper body portion 3 has a dependent skirt 280 which is configured to engage with the threaded spout 18 of a container 10 in a rotating fashion. The lower body portion 4 is engaged with the spout 18 in a non-rotating fashion, thereby allowing rotational movement between the lower body portion 4 and the upper body portion 3. In this configuration, spillage is prevented from the outlet 8 by an induction seal 50. In the configuration shown in FIG. 31, the lower body portion 4 is composed of an inner member 4a and an outer member 4b respectively, which are engaged to each other in a locked fashion. Outer member 4b is further attached to the upper body portion 3 by moving mechanism of a frangible tamper strip 290 which obstructs relative movement between the upper body portion 3 and the lower body portion 4. It is envisaged that members 4a and 4b will be moulded independently of each other, with outer member 4b being moulded together with the upper body portion 3. Inner member 4a will then be engaged in a fixed manner with the spout 18 so that it cannot rotate. The outer member 4b will then be pressed onto the inner member 4a, so'that they lock together to prevent relative rotational movement between the inner member 4a and the outer member 4b. This may be accomplished by a wide variety of known moving mechanism, of which a skilled reader will be familiar. When the upper body portion 3 is rotated relative to the lower body portion 4, the frangible tamper strip 290 will break, thereby leaving evidence that the flow switch 1 has been opened.

It will be appreciated that in the embodiments shown in FIGS. 31, 32 and 33, there will be significant advantages in being able to seal the flow switch 1 by means of a single induction seal.

Preferably, said upper body portions and lower body portion may be attached to each other by moving mechanism of a frangible tamper strip obstructing relative movement between the upper body portion and the lower body portion.

Preferably, said tamper strip may restrict the flow of fluid from operationally flowing from the interface outlet.

The upper body portion or the lower body portion may be composed of a plurality of pieces in locking engagement.

Where reference is made to upper body portion, it may also be considered a first body portion that is preferably in an upper location relative to the other portion.

Where reference is made to lower body portion, it may also be considered a second body portion that is preferably in a lower location relative to the other portion.

We claim:

1. A flow switch assembly comprising;
(i) a valve housing which includes an upper body portion and a lower body portion, the upper and lower body portions defining a chamber to capture a valve member, the housing including an inlet and outlet to said chamber;
(ii) a valve member seated by the chamber of the valve housing, said valve member mounted for movement between a position (herein after “open position”) allowing fluid passage between and/or via said inlet and said outlet and a position (herein after “closed position”) wherein said valve member seals at least one of said inlet and outlet; and
(iii) moving mechanism operatively associated with said valve housing and the valve member for moving the valve member between the open position and the closed position when the upper body portion of the housing is rotated relative to said lower body portion.

2. A flow switch as claimed in claim 1 wherein a seal (such as an induction seal) is provided to the valve housing to seal the outlet.

3. A flow switch as claimed in claim 2, wherein said seal (such as an induction seal) is engaged to said upper body and is located to close said opening of said upper body.

4. A flow switch as claimed in claim 1, wherein said inlet and said outlet are disposed opposite each other on the valve member.

5. A flow switch as claimed in claim 2, wherein said seal is a plastic film.

6. A flow switch as claimed in claim 2, wherein said seal is a plastic cap that includes an annular lip that engages said upper body portion to seal said outlet.

7. A flow switch as claimed in claim 6, wherein said seal threadingly engages with a thread of the upper body portion.

8. A flow switch as claimed in claim 6, wherein said seal threadingly engages with a thread of the lower body portion.

9. A flow switch as claimed in claim 6, wherein said seal includes a wad seal to assist in sealing the outlet.

10. A flow switch as claimed in claim 1, wherein the upper body portion and the lower body portion engage with each other at an interface between an upper body engaging surface and a lower body engaging surface respectively.

11. A flow switch as claimed in claim 10, wherein the interface between the upper body engaging surface and the lower body engaging surface defines an interface passage.

12. A flow switch as claimed in claim 11, wherein the interface passage has an interface passage inlet at the chamber.

13. A flow switch as claimed in claim 11, wherein the interface passage has an interface passage outlet at the periphery of the valve housing.

14. A flow switch as claimed in claim 11, wherein the interface passage outlet is proximate the outlet and preferably about the outlet.

15. A flow switch as claimed in claim 11, wherein the interface passage outlet is proximate the inlet and preferably about the inlet.

16. A flow switch as claimed in claim 1 wherein the upper body portion is received into a recess in the lower body portion.

17. A flow switch as claimed in claim 1 wherein the lower body portion is received into a recess in the upper body portion.

18. A flow switch as claimed in claim 1 wherein the valve housing has a proximal end and a distal end.

19. A flow switch as claimed in claim 1, wherein the valve housing is cylindrical, having a proximal end and a distal end

20. A flow switch as claimed in claim 11 wherein the valve housing has a proximal end and a distal end and wherein the interface passage outlet is proximate the outlet on a distal end of the cylindrical housing.

21. A flow switch as claimed in claim 11 wherein the valve housing has a proximal end and a distal end and wherein the interface passage outlet is proximate the inlet on a distal end of the cylindrical housing.

22. A flow switch as claimed in claim 11, wherein said seal engages with the valve housing to restrict the flow of fluid from operationally flowing from the interface passage outlet.

23. A flow switch as claimed in claim 10, wherein the interface between the upper body portion and the lower body portion includes a labyrinth seal.

24. A flow switch as claimed in claim 1 wherein said flow switch includes a frangible tamper strip obstructing relative movement between the upper body portion and the lower body portion.

25. A flow switch as claimed in claim 24, wherein said tamper strip restricts the flow of fluid from operationally flowing from the interface outlet.

26. A consumer beverage container comprising;
(i) a container portion,
(ii) a lower valve body portion integrally formed with said container portion,
(iii) an upper valve body portion rotatably engaged with said lower valve body portion and defining with said lower valve body portion a chamber to capture a valve member, said lower valve body portion including a passage creating an inlet to said chamber to allow fluid passage between said container portion and said chamber, the upper valve body portion including an outlet to said chamber,
(iv) a valve member disposed within the chamber, said valve member mounted for movement between a position (hereinafter “open position”) allowing fluid passage between and/or via said inlet and said outlet and a position (hereinafter “closed position”) wherein said valve member seals at least one of said inlet and outlet,
(v) moving mechanism operatively associated with (i) at least one of (a) said upper and (b) lower valve body portions, and (ii) the valve member, for moving the valve member between the open position and the closed position when the upper valve body portion of the housing is rotated relative to said lower valve body portion;

27. A container as claimed in claim 26, wherein a seal (such as an induction seal) is provided to seal the outlet

28. A container as claimed in claim 26 wherein the valve member is mounted for pivoting movement between the open position and closed position.

29. A container as claimed in claim 26 wherein the valve member is at least partially spherical, and includes a passage through it.

30. A container as claimed in claim 26 wherein the upper body portion and the lower body portion engage with each other at an interface between an upper body engaging surface and a lower body engaging surface respectively.

31. A container as claimed in claim 30, wherein the interface between the upper body engaging surface and the lower body engaging surface defines an interface passage.

32. A container as claimed in claim 31, wherein the interface passage has an interface outlet at or in fluid connection with the periphery of the valve housing.

33. A container as claimed in claim 31, wherein the interface passage has an interface passage inlet at or in fluid connection with the chamber.

34. A container as claimed in claim 31, wherein the interface passage outlet is proximate the outlet and preferably about the outlet.

35. A container as claimed in claim 31, wherein the interface outlet is proximate the inlet and preferably about the inlet

36. A fluid container comprising;
(i) a housing which includes an upper body portion and a lower body portion, the upper and lower body portions defining a chamber capturing a container member, the housing including an outlet to said chamber;
(ii) a container member disposed within the chamber of the housing, said container member including a reservoir to contain fluid and including at least one fluid outlet, said container member mounted for movement between a position (herein after “open position”) allowing fluid passage between and/or via said fluid outlet of said container member and said outlet to said chamber and a position (herein after “closed position”) wherein said container member seals said outlet of said chamber and
(iii) moving mechanism operatively associated with said housing and the container member for moving the container member between the open position and the closed position when the upper body portion of the housing is rotated relative to said lower body portion.

37. A container as claimed in claim 36, wherein the outlet is sealed by a seal (such as an induction seal).

38. A container as claimed in claim 36, wherein said container member is substantially spherical in shape.

39. A container as claimed in claim 36, wherein said chamber of said housing is of a substantially complementary shape to said spherical container member.

40. A container as claimed in claim 36, wherein the upper body portion and the lower body portion may engage with each other at an interface between an upper body engaging surface and a lower body engaging surface respectively. A container as claimed in claim 36, wherein the interface between the upper body engaging surface and the lower body engaging surface defines an interface passage that is exposed to the surrounds at and about said outlet.

41. A fluid switch assembly comprising;
(i) a valve housing which includes an upper body portion and a lower body portion, the upper and lower body portions defining a chamber to capture a valve member, the housing including an inlet and outlet to said chamber;
(ii) a valve member disposed within the chamber of the valve housing, said valve member mounted for movement between a position (herein after “open position”) allowing fluid passage between and/or via said inlet and said outlet and a position (herein after “closed position”) wherein said valve member seals at least one of said inlet and outlet; and
(iii) moving mechanism operatively associated with said valve housing and the valve member for moving the valve member between the open position and the closed position when the upper body portion of the housing is rotated relative to said lower body portion;
(iv) wherein the upper body portion is received substantially into a recess in the lower body portion.

42. A fluid switch assembly as claimed in claim 41, wherein said lower body portion provides said inlet to said chamber, and wherein said lower body portion is integrally formed with a container said container including an opening contiguous said inlet to said chamber.

43. A fluid switch assembly as claimed in 42 wherein said container is a consumer beverage container.

44. A fluid switch assembly as claimed in claim 41 wherein the upper body portion and the lower body portion engage with each other at an interface between an upper body engaging surface and a lower body engaging surface respectively.

45. A fluid switch assembly as claimed in claim 44, wherein the interface between the upper body engaging surface and the lower body engaging surface defines an interface passage.

46. A fluid switch assembly as claimed in claim 45, wherein the interface passage has an interface inlet at or in fluid communication with the chamber.

47. A fluid switch assembly as claimed in claim 45, wherein the interface passage has an interface outlet at or towards or in fluid communication with the periphery of the valve housing.

48. A fluid switch assembly as claimed in claim 45 wherein the interface passage outlet is proximate the outlet.

49. A fluid switch assembly as claimed in claim 45, wherein the interface passage outlet is proximate the inlet.

50. A fluid switch assembly as claimed in claim 45, wherein the valve housing has a proximal end and a distal end.

51. A fluid switch assembly as claimed in claim 45, wherein the valve housing is cylindrical, having a proximal end and a distal end

52. A fluid switch assembly as claimed in claim 51 , wherein the interface passage outlet is proximate the outlet on a distal end of the cylindrical housing.

53. A fluid switch assembly as claimed in claim 51, wherein the interface passage outlet is proximate the inlet on a proximal end of the cylindrical housing.

54. A fluid switch assembly as claimed in claim 41, wherein the upper body portion and the lower body portion engage with each other at an interface between an upper body engaging surface and a lower body engaging surface respectively and wherein said fluid switch assembly includes a seal which engages with the valve housing to restrict the flow of fluid from operationally flowing from said chamber out through said interface.

55. A fluid switch assembly as claimed in claim 54, wherein said seal is an induction seal.

56. A fluid switch assembly as claimed in claim 44, wherein the interface between the upper body portion and the lower body portion includes a labyrinth seal.

57. A fluid switch assembly as claimed in claim 54, wherein said seal (such as an induction seal) is engaged to said upper body.

58. A fluid switch assembly as claimed in claim 54, wherein said seal (such as an induction seal) is a plastic film (one or multiple).

59. A fluid switch assembly as claimed in claim 54, wherein said seal is a plastic cap that includes an annular lip that engages said upper body portion to seal said outlet.

60. A fluid switch assembly as claimed in claim 54, wherein said seal threadingly engages with a thread formation on one of said lower and upper body portions.

61. A fluid switch assembly as claimed in claim 54, wherein said seal includes a wad seal to assist in sealing the outlet.

62. A fluid switch assembly as claimed in claim 41 wherein said upper body portions and lower body portion are attached to each other by a frangible tamper strip obstructing relative movement between the upper body portion and the lower body portion.

63. A flow switch suitable for regulating the flow of fluid, said flow switch comprising
(i) a valve housing which includes an upper body portion and a lower body portion, the upper and lower body portions defining a chamber to capture a valve member, the housing including an inlet and outlet to said chamber;
(ii) a valve member seated in the chamber of the valve housing, said valve member mounted for movement between a position (herein after “open position”) allowing fluid passage between and/or via said inlet and said outlet and a position (herein after “closed position”) wherein said valve member seals at least one of said inlet and outlet; and
(iii) a cam and at least one cam follower are associated with said valve housing and the valve member to effect movement of the valve member between the open position and the closed position when the upper body portion of the housing is rotated relative to said lower body portion;
wherein the lower body portion is received substantially into a recess in the upper body portion.

64. A flow switch assembly comprising;
(i) a valve housing which includes a first body portion and a second body portion, the first body portion rotatably mounted in said second body portion, the first body portion and second body portion defining a chamber in said valve housing to capture a valve member, the first body portion defining a first opening and the second body portion defining a second opening to said chamber,
(ii) a valve member seated in the chamber of the valve housing, said valve member mounted for movement between a position (herein after “open position”) allowing fluid passage between and/or via said first and second openings and a position (herein after “closed position”) wherein said valve member prevents fluid passage between and/or via said first and second openings,
(iii) at least one cam and at least one cam follower associated with said valve housing and the valve member to effect movement of the valve member between the open position and the closed position when the first body portion of the housing is rotated relative to said second body portion.

65. A flow switch as claimed in claim 64 wherein the first body portion is located completely in said second body portion yet is accessible by a user via an aperture of said second body portion, said aperture at the surface of the second body portion extending about the first opening.

66. A flow switch as claimed in claim 64 wherein the first body portion is located in said second body portion and presents said first opening at an aperture of said second body portion, said aperture at the surface of the second body portion extending about the first opening.

67. A flow switch as claimed in claim 64 wherein the first body portion at the first opening is journaled with said second body portion at the first opening, the interface of the first body portion and second body portion at the journal region extending about the first opening.

68. A flow switch as claimed in claim 64 wherein no seams exist between said first and second body portions that exit the valve housing other than about the first opening.

69. A flow switch as claimed in claim 64 wherein an overcap is engaged to said second body portion to locate over and close said first opening.

70. A flow switch as claimed in claim 65 wherein an overcap is engaged to said second body portion to locate over and close said first opening and said aperture of said second body portion to seal any fluid connection between said cavity and the exterior of the flow switch via said aperture.

71. A flow switch as claimed in claim 65 wherein a film seal is engaged to said second body portion to extend over said first opening to close said first opening and said aperture of said second body portion to seal any fluid connection between said cavity and the exterior of the flow switch via said aperture.

72. A flow switch assembly comprising;
(i) a valve housing which includes a first body portion and a second body portion, the second body portion includes a cavity having an aperture at a surface of said second body portion, the first body portion is rotatably mounted in the cavity of said second body portion and extends at least to said aperture to be actuable by a user for rotation relative to the second body portion, the first body portion and second body portion defining a chamber in said valve housing to capture a valve member, the first body portion defining a first opening to said chamber at and about which said aperture extends, the second body portion including a second opening to said chamber,
(ii) a valve member seated in the chamber of the valve housing, said valve member mounted for movement between a position (herein after “open position”) allowing fluid passage between and/or via said first and second openings and a position (herein after “closed position”) wherein said valve member prevents fluid passage between and/or via said first and second openings,
(iii) at least one cam and at least one cam follower associated with said valve housing and the valve member to effect movement of the valve member between the open position and the closed position when the first body portion of the housing is rotated relative to said second body portion.
